(19) United States
(12) Patent Application Publication
(10) Pub. No.: US 2024/0007599 A1
(43) Pub. Date: Jan. 4, 2024

(54) INFORMATION PROCESSING SYSTEM, INFORMATION PROCESSING DEVICE, INFORMATION PROCESSING METHOD, INFORMATION PROCESSING PROGRAM, IMAGING DEVICE, CONTROL METHOD OF IMAGING DEVICE, AND CONTROL PROGRAM

(71) Applicant: Sony Group Corporation, Tokyo (JP)

(72) Inventor: Soichiro MAITA, Tokyo (JP)

(73) Assignee: Sony Group Corporation, Tokyo (JP)

(21) Appl. No.: 18/030,905

(22) PCT Filed: Aug. 10, 2021
(86) PCT No.: PCT/JP2021/029479

§ 371 Date: Apr. 7, 2023

(30) Foreign Application Priority Data
Oct. 16, 2020 (JP) 2020-174572

(51) Int. Cl. H04N 9/64; G06V 10/56; G06V 20/40

(52) U.S. Cl. CPC H04N 9/64; G06V 10/56; G06V 20/46

(57) ABSTRACT

There is provided an information processing system, an information processing device, an information processing method, an information processing program, an imaging device, a method of controlling an imaging device, and a control program capable of applying processing of an optimum color to a specific scene in a video. The information processing system includes the imaging device and the information processing device, in which the information processing device acquires video data captured by the imaging device, scene specifying information, and LUT setting information from the imaging device, specifies a scene of the video data on the basis of the scene specifying information, and sets LUT data to be applied to the scene on the basis of the LUT setting information.

### TECHNICAL FIELD

The present technology relates to an information processing system, an information processing device, an information processing method, an information processing program, an imaging device, a control method of an imaging device, and a control program.

### BACKGROUND ART

Conventionally, processing such as color grading has been performed on videos or images captured by imaging devices in order to emphasize subjects, adjust an atmosphere or hue, and express a world view or an intention of a creator.

The color grading is processing for correcting a color of a video in a video work such as a movie, and is processing performed for determining a tone throughout the video, matching a color tone of preceding and following cuts, or emphasizing a scene.

In a digital camera, a technique has been proposed in which, when imaged data including (environment information) such as temperature or humidity at the time of imaging is reproduced and displayed, a parameter for applying processing of giving an atmosphere or realistic feeling to the imaged data is set in light of the environment information, and processing is applied to the imaged data using the set parameter (Patent Document 1).

### CITATION LIST

### Patent Document

Patent Document 1: Japanese Patent Application Laid-Open No. 2015-233186

### SUMMARY OF THE INVENTION

### Problems to be Solved by the Invention

However, the technique described in Patent Document 1 does not specify or extract a scene of video data to be processed using a parameter, and is not sufficient in that processing using a parameter is performed on an optimal scene suitable for the parameter.

The present technology has been made in view of such a point, and an object of the present technology is to provide an information processing system, an information processing device, an information processing method, an information processing program, an imaging device, a method of controlling an imaging device, and a control program capable of applying processing of an optimum color to a specific scene in a video.

### Solutions to Problems

In order to solve the above-described problem, a first technology is an information processing system including an imaging device and an information processing device, in which the information processing device acquires video data captured by the imaging device, scene specifying information, and LUT setting information from the imaging device, specifies a scene of the video data on the basis of the scene specifying information, and sets LUT data to be applied to the scene on the basis of the LUT setting information.

Furthermore, a second technology is an information processing device that acquires video data, scene specifying information, and LUT setting information, specifies a scene in the video data on the basis of the scene specifying information, and sets LUT data to be applied to the scene on the basis of the LUT setting information.

Furthermore, a third technology is an information processing method including acquiring video data, scene specifying information, and LUT setting information, specifying a scene in the video data on the basis of the scene specifying information, and setting LUT data to be applied to the scene on the basis of the LUT setting information.

Furthermore, a fourth technology is an information processing program causing a computer to execute an information processing method including acquiring video data, scene specifying information, and LUT setting information, specifying a scene in the video data on the basis of the scene specifying information, and setting LUT data to be applied to the scene on the basis of the LUT setting information.

Furthermore, a fifth technology is an imaging device that generates video data by imaging, extracts a scene from the video data on the basis of scene specifying information, and sets LUT data to be applied to the scene on the basis of LUT setting information.

Furthermore, a sixth technology is a method of controlling an imaging device, including generating video data by imaging, extracting a scene from the video data on the basis of scene specifying information, and setting LUT data to be applied to the scene on the basis of LUT setting information.

Furthermore, a seventh technology is a control program causing a computer to execute a method for controlling an imaging device including generating video data by imaging, extracting a scene from the video data on the basis of scene specifying information, and setting LUT data to be applied to the scene on the basis of LUT setting information.

### BRIEF DESCRIPTION OF DRAWINGS

FIG. 1 is a block diagram illustrating a configuration of an information processing system.

FIG. 2 is a block diagram illustrating a configuration of an imaging device 100.

FIG. 3 is a block diagram illustrating a configuration of an information processing device 200.

FIG. 4 is a block diagram illustrating a configuration of a processing block of the information processing device 200.

FIG. 5 is an explanatory diagram of association between LUT data and metadata.

FIG. 6 is a flowchart illustrating recording data generation processing.

FIG. 7 is a diagram illustrating arrangement of video data and metadata in recording data.

FIG. 8 is a configuration example of data in a user data area.

FIG. 9 is a diagram illustrating a data configuration of an LUT application table.

FIG. 10 is a specific example of a user interface for condition input.

FIG. 11 is a flowchart illustrating processing of generating an LUT application table.

FIG. 12 is an explanatory diagram of association between scenes of video data and LUT data.

FIG. 13 is a specific example of a user interface for condition input.

FIG. 14 is a flowchart illustrating reproduction processing of video data.

FIG. 15 is a block diagram illustrating a modification of the imaging device 100 and the information processing device 200.

### MODE FOR CARRYING OUT THE INVENTION

Hereinafter, embodiments of the present technology will be described with reference to the drawings. Note that the description will be given in the following order.
<1. Embodiments>
[1-1. Configuration of Information Processing System 10]
[1-2. Configuration of Imaging Device 100]
[1-3. Configuration of Information Processing Device 200]
[1-4. Processing in Information Processing Device 100]
[1-4-1. Recording Data]
[1-4-2. LUT Application Table]
[1-4-3. Video Data Reproduction in LUT-Applied Reproduction Mode]
<2. Modifications>

### 1. EMBODIMENTS

[1-1. Configuration of Information Processing System 10]

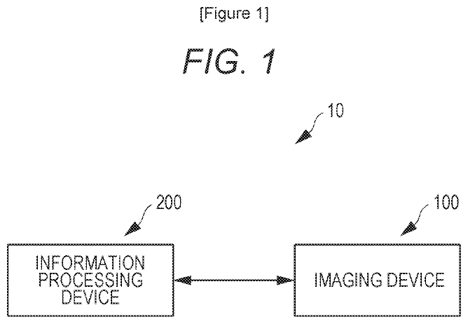

As illustrated in FIG. 1, an information processing system 10 includes an imaging device 100 and an information processing device 200. The information processing device 200 may be configured as a single device, or may be configured to operate in a personal computer, a tablet terminal, a smartphone, a server device, or the like. In this way, it is useful that a device other than the imaging device 200 functions as the information processing device 200 particularly in a case where color grading by LUT data is applied to video data in post-production.

[1-2. Configuration of Imaging Device 100]

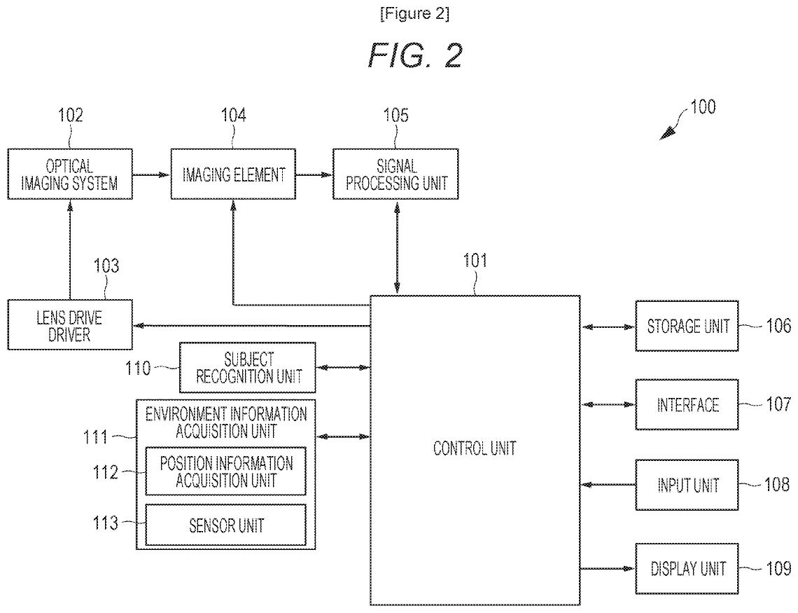

A configuration of the imaging device 100 will be described with reference to FIG. 2. The imaging device 100 includes a control unit 101, an optical imaging system 102, a lens drive driver 103, an imaging element 104, a signal processing unit 105, a storage unit 106, an interface 107, an input unit 108, a display unit 109, a subject recognition unit 110, and a position information acquisition unit 112 and a sensor unit 113 included in an environment information acquisition unit 111.

The control unit 101 includes a central processing unit (CPU), a random access memory (RAM), a read only memory (ROM), and the like. The CPU executes various processes according to programs stored in the ROM and issues commands, thereby controlling the entire imaging device 100 and each unit.

The optical imaging system 102 includes an imaging lens for condensing light from a subject on the imaging element 104, a drive mechanism for moving the imaging lens to perform focusing and zooming, a shutter mechanism, an iris mechanism, and the like. These are driven on the basis of control signals from the control unit 101 and the lens drive driver 103. An optical image of the subject obtained through the optical imaging system 102 is formed on the imaging element 104.

The lens drive driver 103 includes, for example, a microcomputer, and moves the imaging lens by a predetermined amount along the optical axis direction on the basis of focus control information supplied from the control unit 101 or the like, thereby performing autofocus or manual focus so as to focus on a target subject. Furthermore, under the control of the control unit 101, operations of the drive mechanism, the shutter mechanism, the iris mechanism, and the like of the optical imaging system 102 are controlled. As a result, adjustment of exposure, adjustment of a diaphragm value (F value), and the like are performed.

The imaging element 104 photoelectrically converts incident light from a subject obtained through the imaging lens into a charge amount and outputs an imaging signal. Then, the imaging element 104 outputs the imaging signal to the signal processing unit 105. As the imaging element 104, a charge coupled device (CCD), a complementary metal oxide semiconductor (CMOS), or the like is used.

The signal processing unit 105 performs correlated double sampling (CDS) processing, auto gain control (AGC) processing, analog/digital (A/D) conversion, and the like on the imaging signal output from the imaging element 104 to create a video signal.

Furthermore, the signal processing unit 105 performs signal processing such as white balance adjustment processing, color correction processing, gamma correction processing, Y/C conversion processing, and auto exposure (AE) processing on the video signal.

The storage unit 106 is, for example, a mass storage medium such as a hard disk or a flash memory. The video data processed by the signal processing unit 105 is stored in a compressed state or an uncompressed state on the basis of a predetermined standard.

The interface 107 is an interface with the information processing device 200, other devices, the Internet, and the like. The interface 107 may include a wired or wireless communication interface. Furthermore, more specifically, the wired or wireless communication interface may include cellular communication such as 3TTE, Wi-Fi, Bluetooth (registered trademark), near field communication (NFC), Ethernet (registered trademark), serial digital interface (SDI), high-definition multimedia interface (HDMI (registered trademark)), universal serial bus (USB), and the like. Furthermore, in a case where the imaging device 100 and the information processing device 200 are connected in hardware, the interface 107 may include a connection terminal between the devices, a bus in the device, and the like (hereinafter, these are also referred to as interfaces in devices). Furthermore, in a case where the imaging device 100 and the information processing device 200 are implemented in a distributed manner in a plurality of devices, the interface 107 may include different types of interfaces for the respective devices. For example, the interface 107 may include both a communication interface and an interface in a device.

The imaging device 100 is connected to the Internet via the interface to acquire various types of information serving as metadata such as weather information and time information.

The input unit 108 is used by the user to give various instructions to the imaging device 100. When an input is made to the input unit 108 by the user, a control signal corresponding to the input is generated and supplied to the control unit 101. Then, the control unit 101 performs various processes corresponding to the control signal. Examples of the input unit 108 include a shutter button for shutter input, physical buttons for various operations, a touch panel, a touch screen integrally configured with a display as the display unit 109, and the like.

The display unit 109 displays video data, image data, a through image, stored image/video data, a graphical user interface (GUI), and the like, which are color-graded with LUT data, such as an electronic view finder (EVF) and a display. Examples of the display unit 109 include an LCD, a PDP, an organic EL panel, and the like.

The subject recognition unit 110 recognizes a specific subject (a face of a person, an object, or the like) from video data generated by imaging using known subject recognition processing. As the known subject recognition technology, a method based on template matching, a matching method based on luminance distribution information of a subject, a method based on a skin color portion included in an image, a feature amount of a human face, or the like, a method using artificial intelligence, or the like may be used. Furthermore, the recognition accuracy may be enhanced by combining these methods.

The position information acquisition unit 112 included in the environment information acquisition unit 111 detects the position of the imaging device 100 such as a global positioning system (GPS) module. The position information is treated as metadata in the information processing device.

The sensor unit 113 included in the environment information acquisition unit 111 is various sensors capable of acquiring information regarding the environment around the imaging device 100 at the time of imaging, which is handled as metadata, such as a temperature sensor, a humidity sensor, an atmospheric pressure sensor, a geomagnetic sensor, and an illuminance sensor.

Note that the imaging device 100 may include an acceleration sensor, an angular velocity sensor, laser imaging detection and ranging (LiDAR), an inertial measurement unit (IMU) module, an altimeter, an azimuth indicator, a biological sensor, and the like, in addition to the position information acquisition unit 112 and the sensor unit 113. Information that can be acquired from these various sensors may also be treated as metadata.

The imaging device 100 is configured as described above. The imaging device 100 may be a smartphone, a tablet terminal, a wearable device, or the like having a camera function in addition to a device specialized in a camera function such as a digital camera, a single-lens reflex camera, a camcorder, a business camera, or a professional specification imaging device.

Note that the position information acquisition unit 112 and the sensor unit 113 may be included in the imaging device 100, may be configured as another device different from the imaging device 100, or may be used in another device. In a case where the position information acquisition unit 112 and the sensor unit 113 are configured as another device or included in another device, the other device transmits position information and sensor information serving as metadata to the imaging device 100 or the information processing device 200.

[1-3. Configuration of Information Processing Device 200]

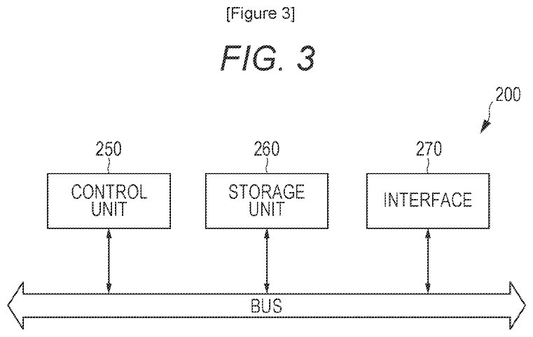

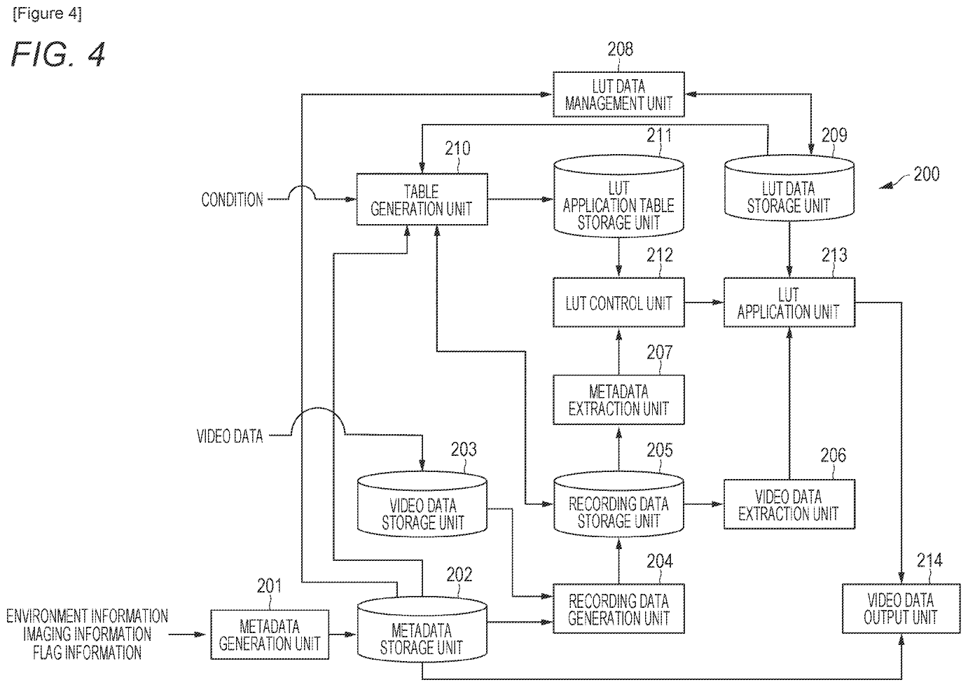

Next, a configuration of the information processing device 200 will be described with reference to FIGS. 3 and 4. As illustrated in FIG. 3, the information processing device 200 includes a control unit 250, a storage unit 260, an interface 270, and an input unit 280.

The control unit 250 includes a CPU, a RAM, a ROM, and the like. The CPU executes various processes according to programs stored in the ROM and issues commands, thereby controlling the entire information processing device 200 and each unit.

The storage unit 260 is, for example, a mass storage medium such as a hard disk or a flash memory.

The interface 270 is an interface with the imaging device 100, other devices, the Internet, and the like. The interface 270 may include a wired or wireless communication interface. Furthermore, more specifically, the wired or wireless communication interface may include cellular communication such as 3TTE, Wi-Fi, Bluetooth (registered trademark), NFC, Ethernet (registered trademark), serial digital interface (SDI), HDMI (registered trademark), USB, and the like. Furthermore, in a case where the imaging device 100 and the information processing device 200 are connected in hardware, the interface 270 may include a connection terminal between the devices, a bus in the device, and the like (hereinafter, these are also referred to as interfaces in devices). Furthermore, in a case where the imaging device 100 and the information processing device 200 are implemented in a distributed manner in a plurality of devices, the interface 270 may include different types of interfaces for the respective devices. For example, the interface 270 may include both a communication interface and an interface in a device.

Although not illustrated, the information processing device 200 may further include an input unit, a display unit, and the like.

As illustrated in FIG. 4, the information processing device 200 includes functional blocks of a metadata generation unit 201, a metadata storage unit 202, a video data storage unit 203, a recording data generation unit 204, a recording data storage unit 205, a video data extraction unit 206, a metadata extraction unit 207, an LUT data management unit 208, an LUT data storage unit 209, a table generation unit 210, an LUT application table storage unit 211, an LUT control unit 212, an LUT application unit 213, and a video data output unit 214.

The metadata generation unit 201, the recording data generation unit 204, the video data extraction unit 206, the metadata extraction unit 207, the LUT data management unit 208, the table generation unit 210, the LUT control unit 212, the LUT application unit 213, and the video data output unit 214 are functions implemented by the control unit 250. Each storage unit such as the metadata storage unit 202, the video data storage unit 203, the recording data storage unit 205, the LUT data storage unit 209, and the LUT application table storage unit 211 is a function implemented in the storage unit 260, and an instruction or control to record data or information in each storage unit is performed by the control unit 250. Furthermore, transmission and reception of video data, scene specifying information, LUT setting information, and other data or information between each functional block of the information processing device 200 and the imaging device 100 are performed using the interface 270.

The metadata generation unit 201 acquires environment information, imaging information, and flag information from the control unit 101, the position information acquisition unit 112, the sensor unit 113, and the subject recognition unit 110 included in the imaging device 100, and extracts information used as metadata to generate metadata. The generated metadata is stored in the metadata storage unit 202. In the present technology, metadata is used as scene specifying information for specifying a scene in video data to which color grading is applied by applying LUT data and LUT setting information for setting LUT data to be used for color grading.

The environment information is information related to an environment in which imaging is performed, such as weather information or time information acquired from the Internet, imaging position information acquired by the position information acquisition unit 112, and temperature information or humidity information acquired by a temperature sensor or a humidity sensor as the sensor unit 113.

The imaging information is information related to imaging, such as lens information (iris, focus, zoom setting) or camera setting information (parameters such as AE photometry mode, white balance, gamma, and color decision list (CDL)) that can be supplied from the control unit 101 or the like of the imaging device 100, and further, face recognition information and object recognition information supplied from the subject recognition unit 110.

The flag information includes reproduction position information (a start frame number and an end frame number of a scene, a start reproduction time and an end reproduction time of a scene, and the like) for identifying a scene in video data, a keyword related to a scene, and the like, which are input by the user. For example, the user can indicate, with the flag information, a special scene, an important scene, a scene to be emphasized, a scene to be subjected to color grading with LUT data, and the like in video data. The user can input the flag information by an input operation to the input unit 108 of the imaging device 100.

In order to associate the environment information and the imaging information as the metadata with the video data, time information indicating the time/duration when the information is acquired is added.

Note that, in the present technology, any one or a combination of the environment information, the imaging information, and the flag information, which are the metadata, is used as the scene specifying information, and both or at least one of the environment information or the imaging information is also used as the LUT setting information. The information processing device 200 acquires the video data, the scene specifying information, and the LUT setting information from the imaging device 100.

The video data storage unit 203 stores video data captured and generated by the imaging device 100. The video data is added with time information indicating the time/duration of imaging in association with the metadata to be recording data.

The recording data generation unit 204 generates recording data by associating video data with metadata. The association between the video data and the metadata is performed by associating metadata having time information matching the time of the frames for each frame constituting the video data. The generated recording data is stored in the recording data storage unit 205.

The video data extraction unit 206 extracts, from the recording data, video data to which color grading is applied by applying the LUT data at the time of reproducing the video data.

The metadata extraction unit 207 extracts the metadata from the recording data when the video data is reproduced.

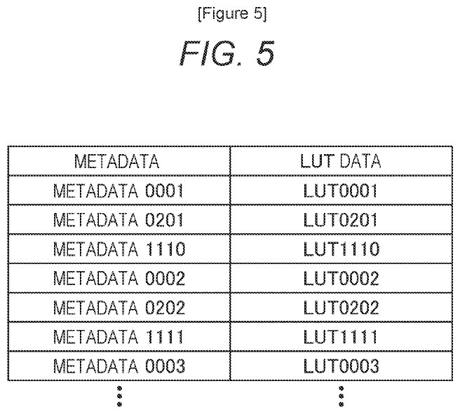

As illustrated in FIG. 5, the LUT data management unit 208 performs processing of storing metadata in the LUT data storage unit 209 in association with the LUT data. The LUT data storage unit 209 stores LUT data used for color grading. The metadata associated with the LUT data functions as LUT setting information.

The association between the LUT data and the metadata may be performed on the basis of an input instruction specifying specific metadata and LUT data by the user. Furthermore, the LUT data management unit 208 may automatically perform the processing according to the features of the LUT data or the intention or use of the creator who has generated the LUT data and the type of metadata.

For example, metadata of “weather: sunny” is associated with LUT data produced with the intention of highlighting a bright blue sky. Further, the LUT data and the metadata may be associated with each other on the basis of a predetermined algorithm, rule, or the like. Note that the association between the LUT data and the metadata is not limited to associating one piece of metadata with one piece of LUT data, and a plurality of pieces of metadata may be associated with one piece of LUT data, or one piece of metadata may be associated with a plurality of pieces of LUT data.

The table generation unit 210 generates an LUT application table in which an application condition and LUT data used for color grading are associated with each other on the basis of the application condition input from the user. The generated LUT application table is stored in the LUT application table storage unit 211. The LUT application table is a table in which an application condition specified by the user for applying color grading to video data is associated with LUT data, and the information processing device 200 applies color grading to the video data with reference to the LUT application table. Details of the LUT application table will be described later.

The LUT is a look up table, and is capable of performing color conversion by converting three RGB numerical values included in a video/image into other RGB numerical values to change the hue of the video/image. The LUT data is preset data for performing color conversion by the LUT, and the LUT data may be created by a user, or may be anything created by a general creator or manufacturer and sold or released for free.

During reproduction of the video data, the LUT control unit 212 determines and switches LUT data to be used for color grading with reference to the LUT application table in response to a change in the scene of the video data, thereby setting LUT data to be applied to the scene.

The LUT application unit 213 applies color grading, which is color correction processing, to the video data by applying the LUT data determined and switched by the LUT control unit 212 during reproduction of the video data. The video data subjected to the color grading is supplied to the video data output unit 214.

The video data output unit 214 performs processing of outputting video data subjected to color grading. Examples of the output method include display on the display unit 109 and transmission to another device via an interface such as SDI or HDMI (registered trademark).

The information processing device 200 is configured as described above. Note that the processing in the information processing device 200 may be implemented by executing a program, and a personal computer, a tablet terminal, a smartphone, a server device, or the like may have a function as the information processing device 200 by executing the program. The program may be installed in advance in the imaging device 100 or the like, or may be distributed by download, a storage medium, or the like and installed by the user himself/herself.

Note that the information processing device 200 may include a video data input unit that inputs video data via an interface such as SDI or HDMI (registered trademark). Furthermore, the information processing device 200 may include a recording medium control unit that stores video data or recording data subjected to color grading in a recording medium such as a USB memory.

Each storage unit constituting the information processing device 200 may be configured in the storage unit 106 of the imaging device 100.

[1-4. Processing in Information Processing Device]

[1-4-1. Recording Data]

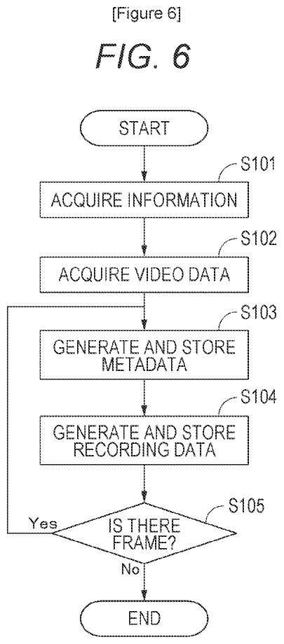

Next, processing in the information processing device 200 will be described. First, recording data generation will be described with reference to FIG. 6.

In step S101, the metadata generation unit 201 acquires various types of information serving as metadata from the control unit 101, the position information acquisition unit 112, the sensor unit 113, and the like of the imaging device 100. Furthermore, in step S102, the information processing device 200 acquires video data from the imaging device 100 and stores the video data in the video data storage unit 203. Note that, although step 3102 is described to be performed after step 3101 for convenience of the drawings, the acquisition of the video data is not necessarily performed later, and the acquisition of the video data may be performed first, or step S101 and step 3102 may be performed asynchronously but simultaneously.

Next, in step S103, the metadata generation unit 201 generates metadata from the acquired various types of information and stores the metadata in the metadata storage unit 202.

Next, in step S104, the recording data generation unit 204 associates the video data with the metadata functioning as the scene specifying information in units of frames constituting the video data to generate the recording data, and stores the recording data in the recording data storage unit 205.

Timing of output of the imaging information or the flag information from the control unit 101 of the imaging device 100, acquisition and output of the position information by the position information acquisition unit 112, and acquisition and output of the sensor information by the sensor unit 113 is not necessarily synchronized (is asynchronous) with the time axis of the video data. Therefore, the recording data generation unit 204 refers to the time information of the video data and the time information of the metadata, and generates the recording data in association with each other on the common time axis. Therefore, the metadata that does not match the time axis of the video data (the timing is not matched) is not associated with the video data. Note that flag information that is reproduction position information indicating a scene in the video data is associated with a start frame and an end frame of the scene indicated by the flag information.

The recording data generation unit 204 generates the recording data by associating the video data with the metadata while repeating this processing in units of frames.

Next, in step S105, it is checked whether there is a remaining frame constituting the video data. In a case where there is a remaining frame, the processing proceeds to step S103 (Yes in step S105). Then, by repeating steps S103 to S105, the recording data generation unit 204 generates recording data by associating the video data and the metadata on a common time axis.

Then, in a case where there is no remaining frame, that is, in a case where the processing has been completed for all the frames, the processing ends (No in step S105).

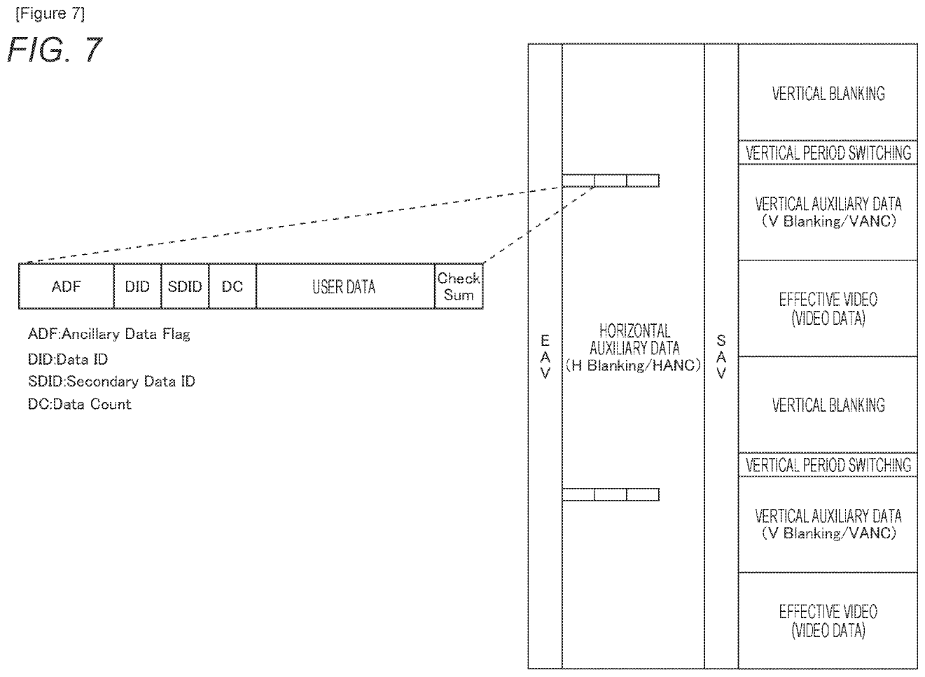

FIG. 7 illustrates a configuration of recording data and an arrangement example of video data and metadata in the recording data. A plurality of pieces of metadata is arranged in the area of the horizontal auxiliary data for each kind of metadata, and the video data is arranged in the area of the effective video data. Furthermore, a user data area exists in the metadata. In the example of FIG. 7, the user data is embedded in the SDI output according to the format of User Defined Acquisition Metadata Set defined in SMPTE RDD 18 Acquisition Metadata.

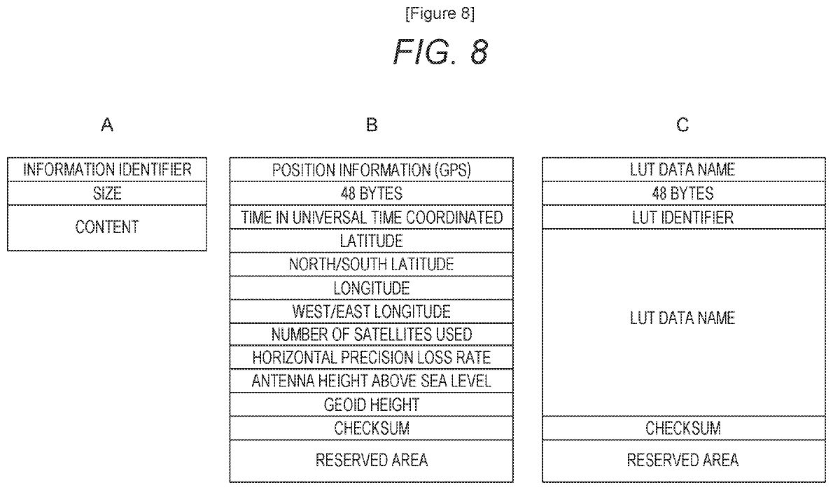

FIG. 8 is a configuration example of data in the user data area. FIG. 8A illustrates a data format in the user data area, and includes an information identifier for discriminating a type of information, a size indicating a content amount of data, and data content itself.

FIG. 8B illustrates position information as metadata as an example of specific data in the user data area. The information identifier is position information (GPS), the size is the number of bytes as the capacity of data including the reserved area, and the data content includes information such as time in universal time coordinated, latitude, north/south latitude, and longitude in a predetermined order and size.

FIG. 8C illustrates LUT data as an example of specific data in the user data area. The information identifier is an LUT data name, the size is the number of bytes as the capacity of data including the reserved area, and the data content includes information such as an LUT data name including an identifier of the LUT data and a file name recorded when the data is read from a file, a checksum, and the like in a predetermined order and size.

[1-4-2. LUT Application Table]

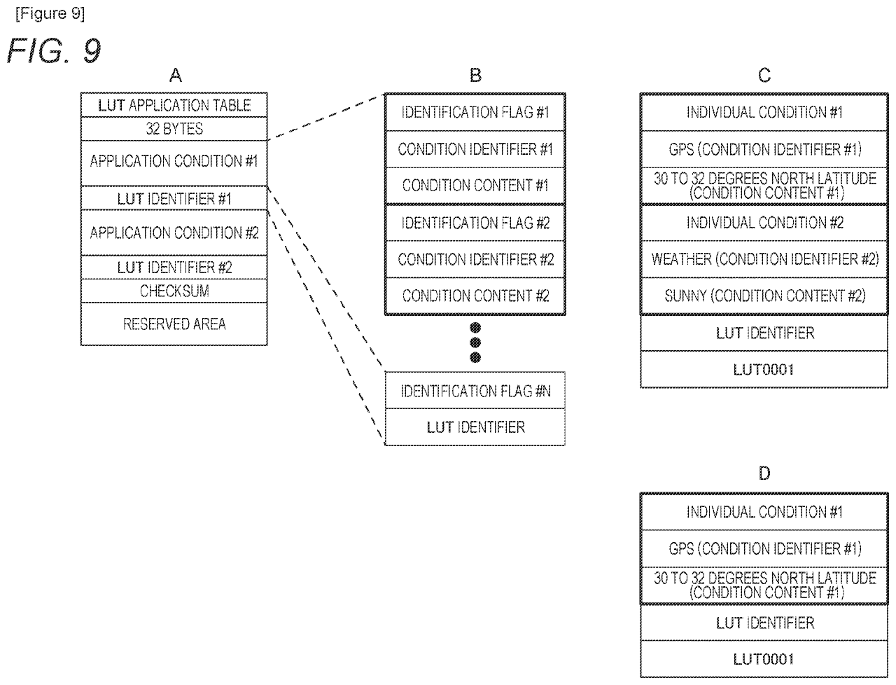

Furthermore, an LUT Application Table as illustrated in FIG. 9 is stored in the user data area. The LUT application table associates an application condition input from the user with LUT data matching the application condition and is used to perform color grading on a scene matching the application condition. The LUT control unit 212 refers to the LUT application table to determine/switch LUT data to be used when the LUT application unit 213 performs color grading on a scene constituting video data. Therefore, in order to reproduce the video data while applying the LUT data, it is necessary to generate the LUT application table for the video data in advance.

The LUT application table is also data according to the format illustrated in FIG. 8A, and as illustrated in FIG. 9A, the size is the number of bytes as the capacity of the data including the reserved area, and the data content includes the application condition, the LUT identifier, and the checksum in a predetermined order and size. Note that the application conditions are provided with distinguishing numbers (#1, #2, #3, . . . ), and the LUT identifiers corresponding to the application conditions are also provided with the same numbers (#1, #2, #3, . . . ), and one application condition and one LUT identifier form a set. The application condition is a condition for specifying and setting a scene in video data to which color grading is applied and LUT data to be applied to the scene as color grading, the scene being specified by an input from a user.

In a case where an application condition is specified and a scene in the video data satisfies the application condition, LUT data indicated by an LUT identifier assigned with the same number as the application condition that satisfies the application condition is applied to the scene and color grading is performed. For example, the LUT data indicated by the LUT identifier #1 is applied to a scene that satisfies the application condition #1, and color grading is performed.

FIG. 9B illustrates a data format of the application condition and the LUT identifier. The application condition includes an identification flag, a condition identifier, and condition contents as one set. The identification flag indicates whether the data is an application condition or an LUT identifier.

The individual condition indicates an individual condition constituting the application condition. For example, in a case where the application condition includes one individual condition, the individual condition includes only the identification flag #1, the condition identifier #1, and the lower condition #1. Furthermore, in a case where the application condition includes two individual conditions, the application condition includes the identification flag #1 indicating the first individual condition #1, the condition identifier #1, the condition content #1, and the identification flag #2 indicating the second individual condition #2, the condition identifier #2, and the condition content #2.

The condition identifier indicates a type of metadata to be an individual condition, and is specifically position information, weather information, or the like included in environment information or imaging information. The condition content has a different configuration for each condition identifier, and indicates a numerical value, a state, or the like serving as a specific condition.

FIG. 9C illustrates a specific example of the application condition #1. In the example of FIG. 9C, the application condition #1 is configured as a combination of the individual condition #1 and the individual condition #2. The individual condition #1 is set as a condition for the positional information by the GPS as indicated by the condition identifier #1 and the condition identifier #2, and the individual condition #2 is set as a condition for weather.

The condition content #1 is a specific value of the position information by the GPS, and in the example of FIG. 9C, the condition content is 30 to 32 degrees north latitude. Furthermore, the condition content #2 is a specific state regarding the weather, and in the example of FIG. 9C, the condition content is that the weather is sunny.

In the example of FIG. 9C, for a scene that satisfies the application condition #1 including the individual condition #1 for position information and the individual condition #2 for weather, LUT data LUT0001 associated in advance with LUT setting information matching the application condition is set as LUT data to be applied to the scene, and color grading is performed.

Note that, in the example of FIG. 9C, the application condition #1 is configured by a combination of two individual conditions, but as illustrated in FIG. 9D, the application condition may be configured by one individual condition, or may be configured by a combination of three or more individual conditions. This is set by condition input from the user.

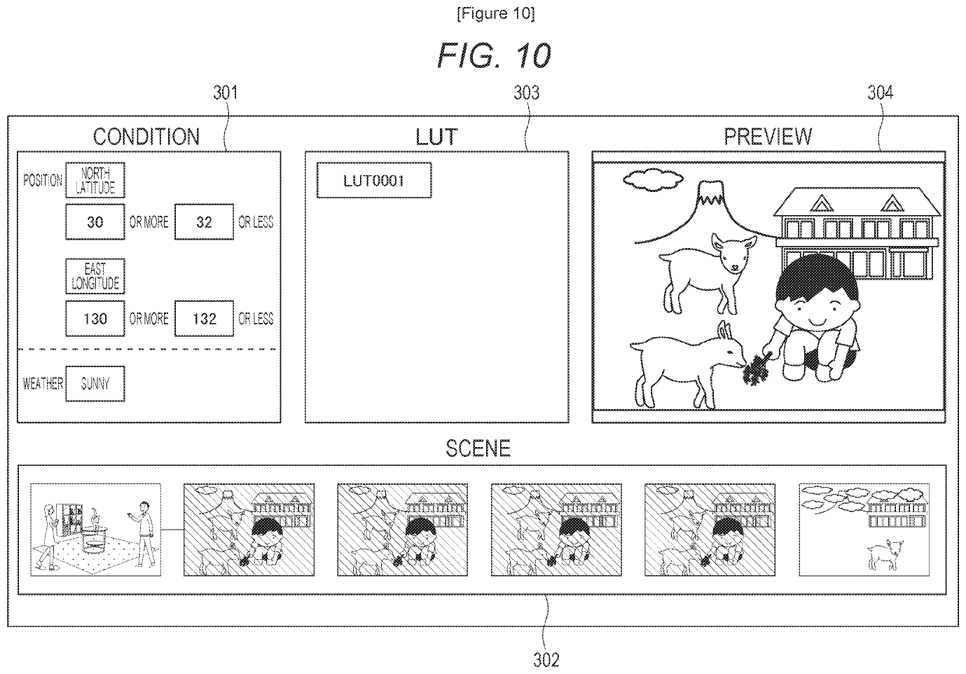

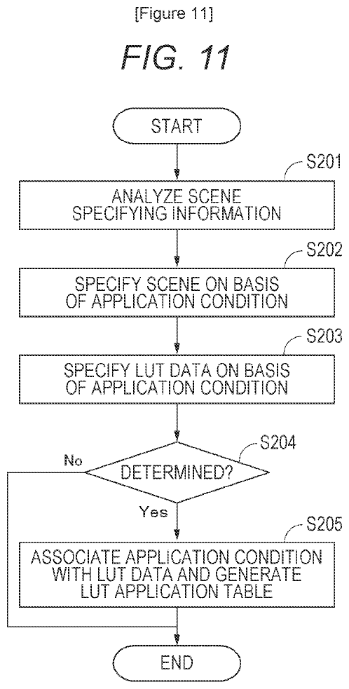

Next, generation of the LUT application table performed by the table generation unit 210 will be described with reference to FIGS. 10 and 11. FIG. 10 is a specific example of a user interface for generating the LUT application table. The user interface is displayed on the device (the imaging device 100 in the present embodiment) on which the information processing device 200 operates. The user interface includes a condition input unit 301, a scene display unit 302, an LUT data presentation unit 303, and a preview display unit 304.

The condition input unit 301 is for inputting an individual condition constituting an application condition. In the example of FIG. 10, the position and the weather are input as conditions, but any information can be input as a condition as long as the information is included in the environment information, the imaging information, and the flag information, and a plurality of conditions may be input in combination.

The scene display unit 302 displays a scene including one or a plurality of frames in the video data associated with the scene specifying information matching the application condition and presents the scene to the user. The user can easily visually confirm what kind of scene the specified scene is by a method such as coloring or marking the scene associated with the scene specifying information matching the application condition among the plurality of frames constituting the video data.

The LUT data presentation unit 303 displays and presents the name of the LUT data associated with the LUT setting information matching the application condition to the user.

The preview display unit 304 displays a result of performing color grading on the video data by applying the LUT data displayed on the LUT data presentation unit 303. By viewing this display, the user can confirm what the result of the color grading using the LUT data is and determine the LUT data to be used for the color grading.

In the generation of the LUT application table, as illustrated in the flowchart of FIG. 11, first, scene specifying information that is metadata associated with the entire video data to be processed is analyzed in step S201.

Next, in step S202, the scene associated with the metadata matching the application condition input to the condition input unit 301 is specified from the video data. This specified scene is displayed on the scene display unit 302 of the user interface.

For example, as illustrated in FIG. 10, in a case where the user inputs an application condition including an individual condition for a position and an individual condition for weather, one or a plurality of frames associated with metadata (scene specifying information) matching the individual condition for the position and metadata (scene specifying information) matching the individual condition for the weather are specified as scenes. As illustrated in FIG. 6, since the video data is associated with the metadata (scene specifying information), the scene corresponding to the scene specifying information matching the application condition can be specified by comparing the application condition with the metadata associated with the video data.

Next, in step S203, LUT data corresponding to LUT setting information matching the application condition is specified as LUT data to be used for color grading for the scene specified in step S202. As illustrated in FIG. 5, since the LUT data is associated with the metadata (LUT setting information), the LUT data corresponding to the LUT setting information matching the application condition can be specified by comparing the application condition with the metadata associated with the LUT data. This specified LUT data is displayed on the LUT data presentation unit 303 of the user interface.

For example, as illustrated in FIG. 10, in a case where the user inputs an application condition including an individual condition for a position and an individual condition for weather, one or a plurality of pieces of LUT data associated with metadata (LUT setting information) matching the individual condition for the position and metadata (LUT setting information) matching the individual condition for the weather are specified.

In a case where the scene to be subjected to the color grading and the LUT data used for the color grading are determined by the user, the processing proceeds from step S204 to step S205 (Yes in step S204). Note that a determination button can be provided on the user interface, or any button of the imaging device 100 can function as a determination input button, whereby the determination input of the user can be received.

Note that, in a case where there is one piece of LUT data displayed in the LUT data presentation unit 303, the user needs to determine whether or not the one piece of LUT data is to be used for color grading. Furthermore, in a case where there is a plurality of pieces of LUT data displayed in the LUT data presentation unit 303, the user needs to determine whether or not to use any of the plurality of pieces of LUT data as LUT data to be used for color grading. Note that, in a case where there is one piece of LUT data displayed in the LUT data presentation unit 303, the table generation unit 210 may automatically determine the one piece of LUT data as the LUT data to be used for color grading even if there is no determination by the user.

Next, in step S205, the LUT application table is generated by associating the application condition with the LUT data to be applied to the scene. As a result, LUT data to be applied to a scene, that is, LUT data to be used for color grading is set.

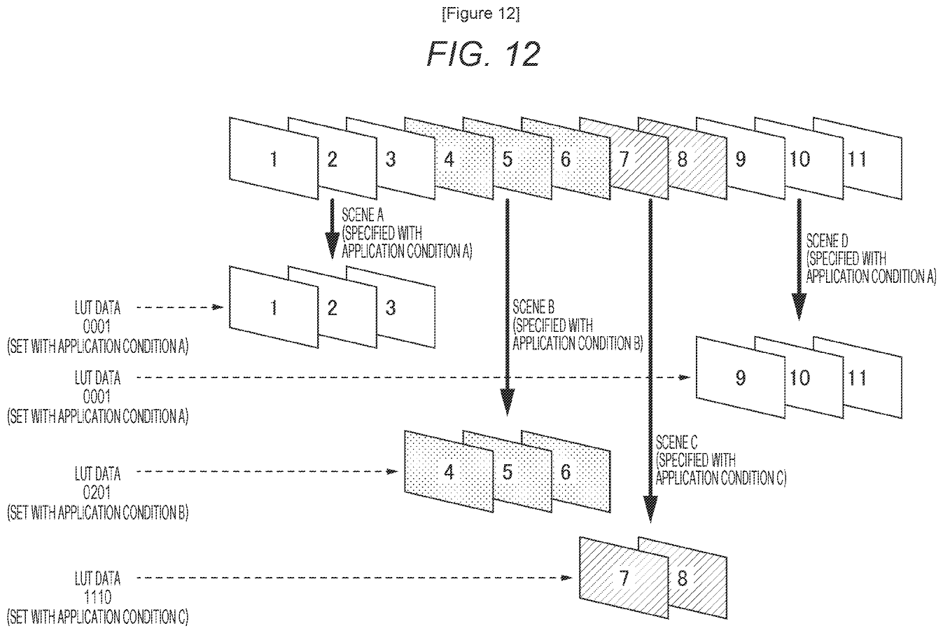

FIG. 12 schematically illustrates a scene including one or a plurality of frames associated with metadata as scene specifying information matching the application condition input as described above, and LUT data associated with metadata as LUT setting information matching the application condition.

In the example of FIG. 12, it is assumed that a total of four scenes of a scene A (frames 1 to 3) specified by the scene specifying information matching the application condition A, a scene B (frames 4 to 6) specified by the scene specifying information matching the application condition B, a scene C (frames 7 and 8) specified by the scene specifying information matching the application condition C, and a scene D (frames 9 to 12) specified by the scene specifying information matching the application condition A are specified.

Then, color grading is performed on the scene A and the scene D specified by the application condition A by applying the LUT data 0001 set with the LUT setting information matching the application condition A. Furthermore, color grading is performed on the scene B specified by the application condition B by applying the LUT data 0201 set with the LUT setting information matching the application condition B. Further, color grading is performed on the scene C specified by the application condition C by applying the LUT data 1109 set with the LUT setting information matching the application condition C.

In a case where a plurality of scenes is specified by the scene specifying information matching the common application condition A as the scene A and the scene D illustrated in FIG. 12, the same LUT data 0001 set with the LUT setting information matching the application condition A is applied to the plurality of scenes to perform color grading.

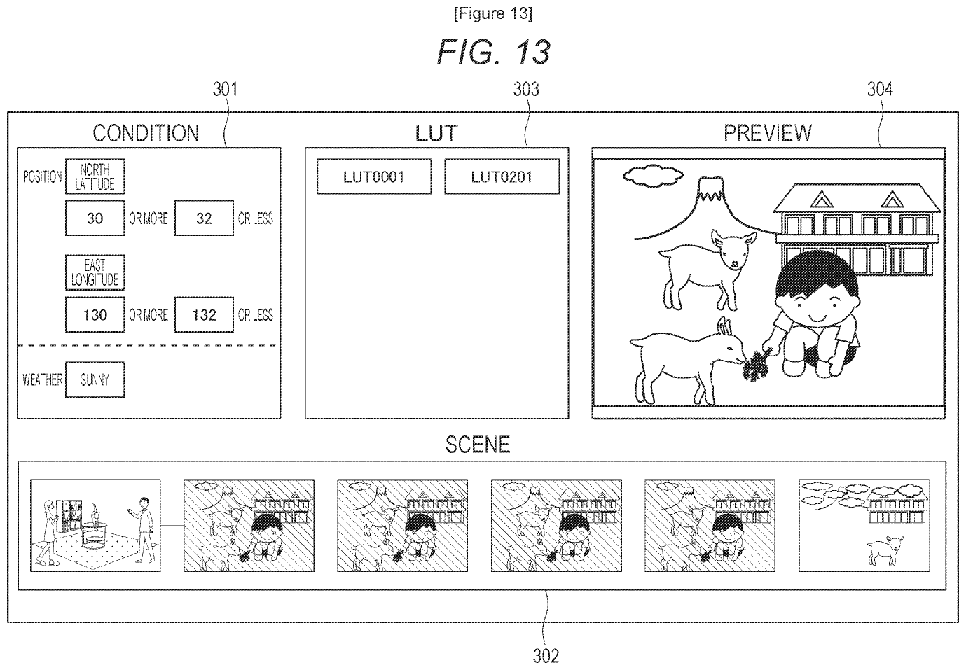

Note that, in a case where there is one piece of LUT data associated with the LUT setting information matching the application condition, one LUT data name is displayed in the LUT data presentation unit 303 as illustrated in FIG. 10. However, in a case where a plurality of pieces of LUT data is associated with one piece of metadata (LUT setting information) in the LUT data stored in the LUT data storage unit 209 illustrated in FIG. 5, a plurality of LUT data names may be displayed in the LUT data presentation unit 303 as illustrated in FIG. 13.

Furthermore, in a case where a plurality of application conditions is input from the user, a plurality of LUT data names may be displayed on the LUT data presentation unit 303 as illustrated in FIG. 13. For example, in a case where the application condition for the position information and the application condition for the weather are input from the user, the LUT data corresponding to the LUT setting information matching the application condition for the position information and the name of the LUT data corresponding to the LUT setting information matching the application condition for the weather are displayed on the LUT data presentation unit 303. In a case where a plurality of LUT data names is displayed, the user selects one piece of LUT data to be used for color grading from the plurality of pieces of presented LUT data. The LUT application table is generated with the selected LUT data, and the LUT data to be applied to the scene is set.

[1-4-3. Video Data Reproduction in LUT-Applied Reproduction Mode]

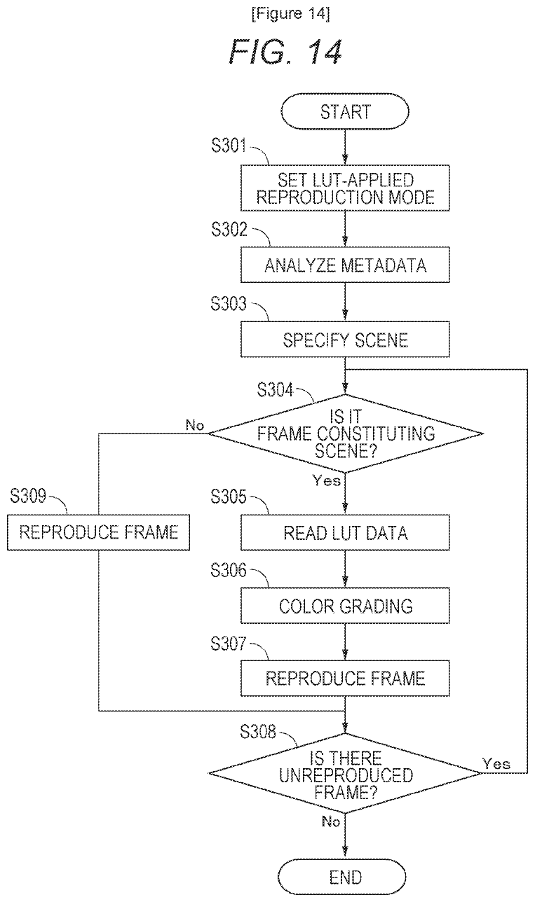

Next, reproduction of video data, which is one aspect of output of video data, will be described with reference to a flowchart of FIG. 14.

First, in step S301, in response to an input from the user or the like, the information processing device 200 refers to the LUT application table and sets the LUT-applied reproduction mode for reproducing the video data while performing color grading with the LUT data. In the LUT-applied reproduction mode, in a case where there is a plurality of scenes to which color grading is applied in a video, LUT data to be applied to each scene is switched in real time, and video data is reproduced in a state where color grading is applied to each scene with the LUT data.

Next, metadata associated with the video data to be reproduced in step S302 is analyzed.

Next, in step S303, a scene associated with scene specifying information which is metadata matching the application condition in the LUT application table is specified. This scene is a scene in which color grading is performed by applying LUT data.

Next, in step S304, it is confirmed whether a frame to be reproduced next is a frame constituting a scene to be subjected to color grading. In a case where the frame to be reproduced next is a frame constituting a scene where color grading is performed, the processing proceeds to step S305 (Yes in step S304).

Next, in step S305, the LUT control unit 212 determines LUT data associated with LUT setting information which is metadata matching the application condition in the LUT application table, as LUT data for color grading and reads the LUT data from the LUT data storage unit 209.

Next, in step S306, the LUT application unit 213 performs color grading by applying the LUT data determined by the LUT control unit 212 to the frame constituting the scene to be subjected to color grading. Then, in step S307, the video data output unit 214 reproduces the frame subjected to the color grading.

In step S308, it is confirmed whether there is an unreproduced frame constituting the video data. In a case where there is an unreproduced frame, the processing proceeds to step 304 (Yes in step S308). Then, in steps S304 to S308, the frame is reproduced while the color grading is performed until the scene subjected to the color grading ends.

On the other hand, in a case where the frame is not the frame constituting the scene subjected to the color grading in step S304, the processing proceeds to step S309 (No in step S304). In this case, in step S309, the video data output unit 214 reproduces a frame that is not subjected to color grading.

Then, as long as there is a frame constituting the video data in step S308, steps S303 to S309 are repeated to reproduce the video data by reproducing the frame.

In a case where there is no unreproduced frame constituting the video data in step S308, that is, in a case where all the frames constituting the video data have been reproduced, the processing ends (No in step S308).

The processing according to the present technology is performed as described above. According to the present technology, by associating video data with metadata (environmental information, imaging information, or flag information) functioning as scene specifying information and LUT setting information, it is possible to automatically specify a scene to be subjected to color grading and determine LUT data.

For example, in a case where the temperature information as the environment information functions as the scene specifying information and the LUT setting information, the color grading can be automatically performed using the LUT data optimum for the scene imaged in the specific temperature environment in the video data.

Furthermore, for example, in a case where the zoom setting as the imaging information functions as the scene specifying information and the LUT setting information, the color grading can be automatically performed using the LUT data optimum for the scene imaged at the specific zoom magnification in the video data. Furthermore, for example, in a case where the face recognition information as the imaging information functions as the scene specifying information and the LUT setting information, the color grading can be automatically performed using the LUT data optimum for the scene where the specific person appears in the video.

Furthermore, for example, in a case where the reproduction position information in the video data as the flag information functions as the scene specifying information, color grading can be automatically performed on a specific scene in the video data specified by the user using the LUT data.

Various pieces of information such as the environment information, the imaging information, and the flag information are used as the scene specifying information and the LUT setting information, whereby color grading can be applied to various scenes.

Furthermore, the scene is specified by the scene specifying information on the basis of the application condition specified by the user, and the LUT data is determined by the LUT setting information on the basis of the application condition, whereby the color grading can be performed semi-automatically reflecting the intention of the user.

Furthermore, by recording the LUT application table in the recording data including the video data, it is possible to reproduce the video while dynamically switching the LUT data by referring to the LUT application table at the time of reproduction. As a result, video reproduction and color grading can be performed only by additional writing of the LUT application table, and the load on the system can be reduced.

### 2. MODIFICATIONS

Although the embodiments of the present technology have been specifically described above, the present technology is not limited to the above-described embodiments, and various modifications based on the technical idea of the present technology are possible.

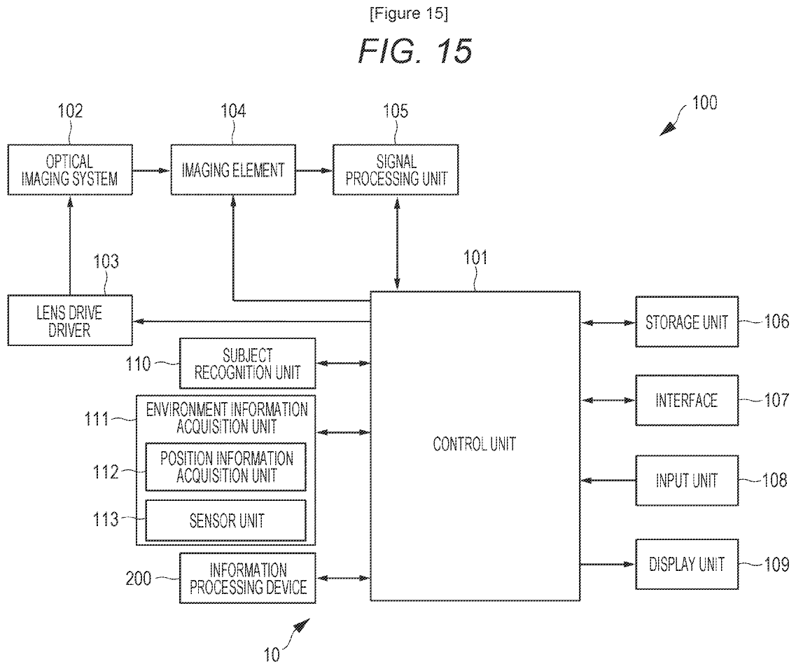

In the embodiments, the imaging device 100 and the information processing device 200 have been described as separate devices, but, as illustrated in FIG. 15, the imaging device 100 may have the function of the information processing device 200, and the information processing device 200 may operate in the imaging device 100. In that case, for example, the control unit 101 and the storage unit 106 in the imaging device 100 have a function as the information processing device 200. The imaging device 100 may have a function as the information processing device 200 by executing the program.

The information processing device 200 associates the video data with the metadata, performs up to processing of generating the LUT application table, and may apply color grading to the video data on the basis of the LUT application table by a device other than the information processing device 200.

The association between the video data and the metadata performed by the recording data generation unit 204 may be performed by the imaging device 100, and the information processing device may acquire the recording data in which the video data and the metadata are associated by the imaging device 100.

The video data may be not only video data generated by imaging, but also video data generated without performing a process of imaging, for example, a CG video, an animation video, and a plurality of images which are switched at a predetermined timing and continuously displayed.

Furthermore, the information processing device 200 may be configured as a cloud system. The cloud is one of use forms of a computer, and is constructed in a server of a cloud service provider. Basically, all necessary processing is performed on the server side. The user stores the data in a server on the Internet instead of the user's own device or the like. Therefore, it is possible to use services, use data, edit data, upload data, and the like even in various environments such as a home, a company, a place outside the office, a shooting site, and an editing room. Furthermore, the cloud system can also transfer various data between devices connected via a network.

Furthermore, it is also possible to transmit recording data to another device different from the device in which the information processing device 200 operates (such as the imaging device 100 illustrated in FIG. 1) and reproduce video data while performing color grading in other device. In this case, the other device that has received the recording data extracts the LUT application table stored in the user data area of the recording data, performs color grading on the basis of the LUT application table, and reproduces the video. Note that transmission and reception of recording data between the information processing device 200 and other devices is not limited to wired or wireless communication, and may be performed via a storage medium such as a USB memory or an SD card.

The present technology can also have the following configurations.

(1)

An information processing system including
an imaging device and an information processing device,
in which the information processing device acquires video data captured by the imaging device, scene specifying information, and LUT setting information from the imaging device, specifies a scene in the video data on the basis of the scene specifying information, and sets LUT data to be applied to the scene on the basis of the LUT setting information.

(2)

The information processing system according to (1), in which the scene specifying information is any one or a combination of information regarding an environment at a time of imaging by the imaging device, information related to an imaging function by the imaging device, and information regarding a reproduction position of the video data.

(3)

The information processing system according to (1) or (2), in which the LUT setting information is at least one of information regarding an environment at a time of imaging by the imaging device or information related to an imaging function by the imaging device.

(4)

The information processing system according to any one of (1) to (3), in which the video data is associated with the scene specifying information for each frame constituting the video data.

(5)

The information processing system according to (4), in which the information processing device specifies one or a plurality of the frame associated with the scene specifying information matching a condition specified by a user as the scene.

(6)

The information processing device according to any one of (1) to (5), in which the LUT data is associated with the LUT setting information.

(7)

The information processing system according to (6), in which the information processing device sets LUT data associated with the LUT setting information matching a condition specified by a user as LUT data to be applied to the scene.

(8)

The information processing device according to (7), in which the information processing device includes a table generation unit that generates an LUT application table in association with the condition and the LUT data associated with the LUT setting information matching the condition.

(9)

The information processing device according to (8), further including an LUT application unit that applies color grading to the video data by applying the LUT data set by referring to the LUT application table.

(10)

The information processing system according to (6), in which in a case where there is a plurality of pieces of the LUT data associated with the LUT setting information matching the condition, the information processing device sets one piece of the LUT data selected by presenting the plurality of pieces of the LUT data to the user as LUT data to be applied to the scene.

(11)

The information processing system according to any one of (1) to (10), in which in a case where a plurality of scenes is specified from the video data on the basis of the scene specifying information, same LUT data is set to be applied to the plurality of scenes on the basis of the LUT setting information.

(12)

An information processing device that acquires video data, scene specifying information, and LUT setting information, specifies a scene in the video data on the basis of the scene specifying information, and sets LUT data to be applied to the scene on the basis of the LUT setting information.

(13)

An information processing method including acquiring video data, scene specifying information, and LUT setting information, specifying a scene in the video data on the basis of the scene specifying information, and setting LUT data to be applied to the scene on the basis of the LUT setting information.

(14)

An information processing program causing a computer to execute an information processing method including acquiring video data, scene specifying information, and LUT setting information, specifying a scene in the video data on the basis of the scene specifying information, and setting LUT data to be applied to the scene on the basis of the LUT setting information.

(15)

An imaging device that generates video data by imaging, extracts a scene from the video data on the basis of scene specifying information, and sets LUT data to be applied to the scene on the basis of LUT setting information.

(16)

A method of controlling an imaging device, including generating video data by imaging, extracting a scene from the video data on the basis of scene specifying information, and setting LUT data to be applied to the scene on the basis of LUT setting information.

(17)

A control program causing a computer to execute a method for controlling an imaging device including generating video data by imaging, extracting a scene from the video data on the basis of scene specifying information, and setting LUT data to be applied to the scene on the basis of LUT setting information.

### REFERENCE SIGNS LIST

10 Information processing system
100 Imaging device
200 Information processing device
213 LUT application unit
210 Table generation unit

1. An information processing system comprising
an imaging device and an information processing device,
wherein the information processing device acquires video data captured by the imaging device, scene specifying information, and LUT setting information from the imaging device, specifies a scene in the video data on a basis of the scene specifying information, and sets LUT data to be applied to the scene on a basis of the LUT setting information.

2. The information processing system according to claim 1,
wherein the scene specifying information is any one or a combination of information regarding an environment at a time of imaging by the imaging device, information related to an imaging function by the imaging device, and information regarding a reproduction position of the video data.

3. The information processing system according to claim 1,
wherein the LUT setting information is at least one of information regarding an environment at a time of imaging by the imaging device or information related to an imaging function by the imaging device.

4. The information processing system according to claim 1,
wherein the video data is associated with the scene specifying information for each frame constituting the video data.

5. The information processing system according to claim 4,
wherein the information processing device specifies one or a plurality of the frame associated with the scene specifying information matching a condition specified by a user as the scene.

6. The information processing device according to claim 1,
wherein the LUT data is associated with the LUT setting information.

7. The information processing system according to claim 6,
wherein the information processing device sets LUT data associated with the LUT setting information matching a condition specified by a user as LUT data to be applied to the scene.

8. The information processing device according to claim 7,
wherein the information processing device includes a table generation unit that generates an LUT application table in association with the condition and the LUT data associated with the LUT setting information matching the condition.

9. The information processing device according to claim 8, further comprising
an LUT application unit that applies color grading to the video data by applying the LUT data set by referring to the LUT application table.

10. The information processing system according to claim 6,
wherein in a case where there is a plurality of pieces of the LUT data associated with the LUT setting information matching the condition, the information processing device sets one piece of the LUT data selected by presenting the plurality of pieces of the LUT data to the user as LUT data to be applied to the scene.

11. The information processing system according to claim 1,
wherein in a case where a plurality of scenes is specified from the video data on a basis of the scene specifying information, same LUT data is set to be applied to the plurality of scenes on a basis of the LUT setting information.

12. An information processing device that
acquires video data, scene specifying information, and LUT setting information, specifies a scene in the video data on a basis of the scene specifying information, and sets LUT data to be applied to the scene on a basis of the LUT setting information.

13. An information processing method comprising
acquiring video data, scene specifying information, and LUT setting information, specifying a scene in the video data on a basis of the scene specifying information, and setting LUT data to be applied to the scene on a basis of the LUT setting information.

14. An information processing program causing a computer to execute an information processing method comprising
acquiring video data, scene specifying information, and LUT setting information, specifying a scene in the video data on a basis of the scene specifying information, and setting LUT data to be applied to the scene on a basis of the LUT setting information.

15. An imaging device that
generates video data by imaging, extracts a scene from the video data on a basis of scene specifying information, and sets LUT data to be applied to the scene on a basis of LUT setting information.

16. A method of controlling an imaging device, comprising
generating video data by imaging, extracting a scene from the video data on a basis of scene specifying information, and setting LUT data to be applied to the scene on a basis of LUT setting information.

17. A control program causing a computer to execute a method for controlling an imaging device comprising
generating video data by imaging, extracting a scene from the video data on a basis of scene specifying information, and setting LUT data to be applied to the scene on a basis of LUT setting information.
